(19) United States
(12) Patent Application Publication
(10) Pub. No.: US 2008/0013586 A1
(43) Pub. Date: Jan. 17, 2008

(54) Narrow band diode pumping of laser gain materials

(76) Inventors: David E. Spence, Mountain View, CA (US); James D. Kafka, Mountain View, CA (US); Alan B. Petersen, Mountain View, CA (US)

Correspondence Address: GRANT ANDERSON LLP;C/O PORTFOLIOIP, P.O. BOX 52050, MINNEAPOLIS, MN, 55402, US

(21) Appl. No.: 11/515,697

(22) Filed: Sep. 5, 2006

Related U.S. Application Data
(60) Provisional application No. 60/714,576, filed on Sep. 6, 2005.

(51) Int. Cl. H01S 3/091; H01S 3/094; H01S 3/08; H01S 3/092

(52) U.S. Cl. 372/70; 372/75; 372/106

(57) ABSTRACT

Methods and devices for narrow band diode pumping of various laser gain materials which for some embodiments reduces or eliminates some thermal problems as well as other optical problems associated with diode pumping of crystalline materials, including anisotropic materials. In some embodiments, a VBG is used to narrow the bandwidth of the pump light from a pump diode source. In some embodiments, pump light from a diode pump source is chosen to have a wavelength centered substantially at an intersection of absorption coefficients for different polarizations of pump light in the laser gain material.

### CROSS REFERENCE TO RELATED APPLICATIONS

This application claims priority under 35 U.S.C. section 119(e) from U.S. Provisional Patent application Ser. No. 60/714,576 titled “Narrow Band Diode Pumping of Laser Gain Materials”, filed Sep. 6, 2005, by Spence, D. et al. which is also incorporated by reference herein in its entirety.

### BACKGROUND

There is an ongoing need for laser systems that produce high power while maintaining good output beam quality, and that can be directly diode pumped. Typically, for a diode pumped laser system, pump light from one or more diode pump sources is directed to a solid state laser gain material or crystal that then emits or amplifies laser radiation at a desired wavelength. For such a system, not all of the pump light is converted to desirable laser radiation; some of the pump light is converted to heat in the laser gain material. Temperature increases and gradients that result from this heat in the laser gain material can lead to several detrimental effects on the performance of the laser system. Examples of such detrimental effects can include bulk thermal lensing, surface bulging and changes to fundamental properties of the laser gain material such as the upper-state lifetime, thermal conductivity and thermal expansion of the material. Although some or most of this heat may be removed using some type of cooling apparatus, the heat generation within the lasing material and resulting temperature variations may still give rise to some or all of these detrimental effects.

Each of these detrimental effects can have a negative effect on the laser system output characteristics. For example, a thermal lens created within the laser gain material as a result of heat generated by the pumping process may limit the maximum achievable output power for the laser system, and may also lead to degradation in the output beam quality. In addition, thermally induced mechanical stresses that result within the laser gain material can also affect the output power and beam quality, and can ultimately lead to fracture or cracking of the laser gain material. Other detrimental effects may also be manifested as a result of the anisotropic properties, such as anisotropic thermo-mechanical and optical properties, of many desirable laser gain materials. This anisotropy may lead to a time varying absorption of pump light by the laser gain material if the polarization of pump light incident on the laser gain material does not remain constant over time as well. In addition, other detrimental effects on the lasing efficiency of a laser system may result from the anisotropic properties. What has been needed are methods and devices for pumping laser gain materials that reduce the detrimental effects of heating of the laser gain material. What has also been needed are robust laser systems, such as solid state laser systems, that produce high quality beams which are stable over time. What has also been needed are devices and methods to produce more uniform absorption of pump light in a laser gain material. What has also been needed are methods to produce narrow band pump light suitable for laser gain materials.

### SUMMARY

In one embodiment, a laser system includes a laser gain material and a narrow band pump source configured to produce pump light at a wavelength at or near an intersection of absorption coefficients for pump light having different polarizations in the laser gain material. In another embodiment, a laser system includes a solid state laser gain material, at least one diode pump source and at least one Volume Bragg Grating (VBG) optically coupled to the diode pump source.

In another embodiment, a method of pumping a solid state laser system includes pumping a laser gain material with a narrow band pump light having a wavelength centered substantially at an intersection of absorption coefficients for different polarizations of pump light in the laser gain material. In yet another embodiment a method of pumping a laser gain material includes emitting pump light from a diode pump source, narrowing the bandwidth of the pump light and directing the pump light into the laser gain material.

In one embodiment, a laser system includes a laser gain material and a narrow band pump source configured to produce pump light at or near a wavelength where the absorption coefficients for pump light having different polarizations are substantially equal in the laser gain material. In another embodiment, a laser system includes a solid state laser gain material, at least one diode pump source and at least one VBG optically coupled to the diode pump source.

In another embodiment, a method of pumping a solid state laser system includes pumping a laser gain material with a narrow band pump light having a wavelength centered substantially at a point where the absorption coefficients for different polarizations of pump light are substantially equal in the laser gain material. In yet another embodiment a method of pumping a laser gain material includes emitting pump light from a diode pump source, narrowing the bandwidth of the pump light and directing the pump light into the laser gain material.

These features of embodiments will become more apparent from the following detailed description when taken in conjunction with the accompanying exemplary drawings.

### BRIEF DESCRIPTION OF THE DRAWINGS

FIG. 1 is a graphical representation of the absorption coefficient versus wavelength of incident light near 808 nm, for 1% Nd:vanadate material with data shown for unpolarized light, light polarized parallel to the c-axis, and light polarized perpendicularly to the c-axis.

FIG. 2 is a graphical representation of the effective absorption coefficient versus wavelength of incident light near 808 nm, having a bandwidth of about 2.5 nm for 1% Nd:YVO₄ material with data shown for unpolarized light, light polarized parallel to the c-axis, and light polarized perpendicularly to the c-axis.

FIG. 3 is a diagrammatic view of a laser system including a lasing medium, a diode pump source with a Volume Bragg Grating (VBG) coupled thereto and configured to pump the lasing medium with narrow band pump light.

FIG. 4 is a graphical representation of the effective absorption coefficient versus wavelength of incident light near 808 nm, for 1% Nd:YVO₄ material with data shown for light having a bandwidth of about 0.5 nm and a bandwidth of about 2.5 nm.

FIG. 5 is a graphical representation of deposited heat in a Nd:YVO₄ crystal for broadband (in Nd(1.3%):YVO₄) and narrowband (in Nd(1.0%):YVO₄) pump light near 808 nm.

FIG. 6 is a graphical representation of unabsorbed power in a Nd:YVO₄ crystal for broadband (in Nd(1.3%):YVO₄) and narrowband (in Nd(1.0%):YVO₄) pump light near 808 nm.

FIG. 7 is a graphical representation of the effective absorption coefficient versus wavelength of incident light near 880 nm, for 1% Nd:YVO₄ material with data shown for unpolarized light, light polarized parallel to the c-axis, and light polarized perpendicularly to the c-axis.

FIG. 8 is a graphical representation of the effective absorption coefficient versus wavelength of incident light near 880 nm, for 1% Nd:YVO₄ material with data shown for light having a bandwidth of about 0.5 nm and a bandwidth of about 2.5 nm.

FIG. 9 is a graphical representation of deposited heat in Nd:YVO₄ crystal for broadband (in Nd(1.3%):YVO₄) and narrow band (in Nd(1.0%):YVO₄) pump light near 880 nm.

FIG. 10 is a graphical representation of unabsorbed power in Nd:YVO₄ crystal for broadband (in Nd(1.3%):YVO₄) and narrow band (in Nd(1.0%):YVO₄) pump light near 880 nm.

### DETAILED DESCRIPTION

Solid state lasers have a wide range of applications in industry and elsewhere due, in large part, to their compact size, reliability and cost effectiveness. However, present solid state lasers do have limitations which may limit their usefulness in some applications. Many of these limitations may result from detrimental effects due to heating, and, particularly, non-uniform heating of the laser gain material by inefficiencies in the pumping of the laser gain material. Other detrimental effects may result from the anisotropic properties of some desirable laser gain materials alone, or in combination with heat effects. For example, desirable laser gain materials such as neodymium doped vanadate (Nd:YVO₄) or ytterbium doped tungstates (Yb:KGW, Yb:KYW or KYbW, collectively referred to as Yb:tungstate) have polarization and wavelength dependent absorption properties as well as thermomechanical properties that are orientation dependant. The absorption coefficients in some embodiments of Nd:YVO₄ have a ratio of about 3.5:1 at 808 nm and about 20:1 at 880 nm. Alternatively, for example, the absorption coefficients in Yb:tungstate have a ratio of about 3:1 at 930 nm and about 6:1 at 980 nm. This anisotropy can lead to a time varying absorption if the polarization of the pump light does not remain constant.

Diode pump sources that include optical fibers or conduits to couple the light to the laser gain material typically provide unpolarized light so that the influence of environmental factors may be reduced or minimized. However, this has the disadvantage that the pump light generally experiences at least two different absorption coefficients in the laser gain material or crystal. Since it is desirable to have most or substantially all of the pump light absorbed by the laser gain material or crystal, it may be desirable that the doping and length of the laser gain crystal be chosen to absorb the pump light that has a polarization direction or orientation that is most weakly absorbed by the laser gain material. Typically, a laser gain material of Nd:YVO₄ having a neodymium concentration of about 1% requires crystals of about 4 mm in length to absorb most of the light polarized along the more weakly absorbed of the two polarization directions. As a result, the light that is polarized along the strongest absorption is often completely absorbed in the first few millimeters of the laser gain material, which may be a crystal, or over less than about-one half the length of the laser gain material required to completely absorb light energy having the more weakly absorbed polarization orientation. This results in more heat being deposited near the pumped input surface of the laser gain crystal, which may result in increased thermal lensing, surface bulging and stresses near the pumped surface of the laser gain material, as well as, possibly, changes to at least some of the fundamental laser gain crystal or material properties.

One way to mitigate the effect of unequal absorption is to reduce the doping concentration of the laser gain material and lengthen the laser crystal so that the fraction of the pump light is absorbed remains essentially the same, but the heat is deposited over a larger volume in the laser gain crystal. This has been described in U.S. Pat. No. 6,185,235 to Chen, et al., filed Nov. 24, 1998, which is incorporated by reference herein in its entirety. However, this technique merely reduces the consequences of the anisotropic absorption rather than addressing the cause. Also, this method is limited to the extent that it is not possible to lower the doping and increase the crystal length ad infinitum.

In many laser gain materials, the absorption coefficients for pump light also vary differently with wavelength as well as crystal orientation. It is thus often possible to find a crystal orientation and pump wavelength where the absorptions are equal or nearly equal, for the different pump light polarization directions or orientations. Using this technique, the differential absorptions in the laser gain material between two polarizations can be greatly reduced. In addition, if the data curves on a graph representing the coefficient of absorption of pump light versus wavelength of pump light for each polarization are not only equal in magnitude, but also cross one another, the variation of pump light absorption with wavelength can be reduced. This technique has been discussed in U.S. Pat. No. 6,891,876 to Sutter et al., filed Aug. 30, 2002, which is incorporated by reference herein in its entirety.

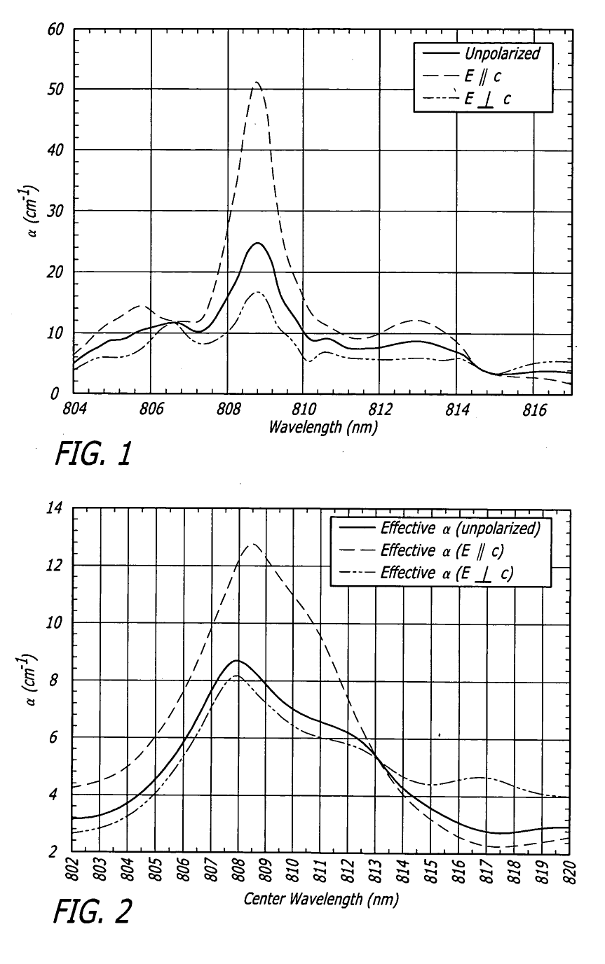

By way of illustration, and without limitation, Nd:YVO₄ may be used as a laser gain material with pump light having wavelengths near 808 nm. The absorption coefficients (a) for Nd:YVO₄ are shown in FIG. 1 for pump light polarized parallel to and perpendicular to a c-axis in a laser gain crystal, together with the effective value of a for unpolarized pump light. The methods discussed in U.S. Pat. No. 6,891,876 to Sutter et al. could be applied, for example, at wavelengths near 815 nm in this example.

However, the absorption of pump light having a wavelength near 815 nm is relatively small compared to the absorption near the peak absorption wavelength of pump light. For example, in Nd:YVO₄, the value of a near a pump light wavelength of 815 nm is less that about 15% of the value near the peak absorption wavelength. As a result, the gain crystal would have to be about seven times longer or about seven times more highly doped in order to achieve the same overall absorption of pump light, but longer crystals that maintain good optical properties are not readily available and/or have significantly higher costs. Higher doping is also not a desirable solution because as the doping concentration in a laser gain material is increased, other effects that adversely affect the laser performance, such as quenching of the upper laser level, can become significant.

Typically, diode pump sources have a full-width half maximum bandwidth equal to or greater than about two nanometers. As a result, the effective absorption coefficient experienced by the pump source is an average over about a few nanometers of the narrow band values. As an example, the effective value of absorption coefficient for Nd:YVO₄ with an input bandwidth of about 2.5 nm is shown in FIG. 2 for pump light which is polarized parallel and perpendicular to a c-axis of the laser gain crystal, as well as for unpolarized light. While this helps somewhat to reduce the differential absorption relative to the peak, (now it is only a factor of about 2.5) it also reduces the range over which the effective absorption is constant with wavelength, and it is also no longer trivial to choose a pump wavelength that equalizes the absorptions along both polarization axes. That is, even though the effective values of the absorption coefficients for both polarizations may be equal, because they may vary differently with wavelength, the exact absorption characteristics within the laser gain crystal will, in general, not be the same for both pump light polarizations. As a result, the pump diodes may still need to be temperature stabilized, thus adding cost and complexity to the apparatus.

As such, many of these problems may be addressed by use of a relatively narrow bandwidth wavelength stabilized diode pump source for pumping laser gain materials. Various embodiments that can be used to achieve substantially fixed wavelength operation from a diode include a Volume Bragg Grating (VBG) such as those manufactured by PD-LD, Inc. in Pennington, N.J., or manufactured by Ondax, Inc. in Monrovia, Calif. These devices can be used to provide a narrow spectral bandwidth from the pump diode, as well as a stabilized central wavelength. Such embodiments have been described in U.S. Provisional Patent Application titled “Line Narrowed Laser Diode System and Method of Use”, Ser. No. 60/623,376, filed by Treusch et al. on Oct. 28, 2004, which is incorporated by reference herein in its entirety. Alternatively, a wavelength selective thin-film coating can be utilized. However, any embodiment that provides an appropriately narrow band and/or wavelength stable pump light source may be used in the embodiments discussed herein.

The use of narrow band, wavelength stabilized pump light sources provides a central wavelength that is very well stabilized. As such, it is relatively straightforward to operate at any point on an absorption curve of a laser gain material, even points where the absorption changes relatively quickly with respect to pump light wavelength, because the pump light wavelength will remain approximately fixed. In addition, because the pump light bandwidth is relatively narrow, the effective values of the absorption coefficients are much closer to the narrow band values, which often result in a higher absorption. This enables the pump light wavelength to be chosen based solely on other properties of the laser gain material, without having to consider how those properties change with pump light wavelength which provides flexibility when designing a laser system. For example, the pump light wavelength may be chosen based on how it will effect the thermo-optical and/or thermo-mechanical properties of the laser gain material or crystal, how it will affect other important properties of the laser such as the intensity required in the laser material to reach transparency or both. Also, the absorption is higher than for the case of broadband pumping so that more conventional shorter, lower doped crystals may still be used.

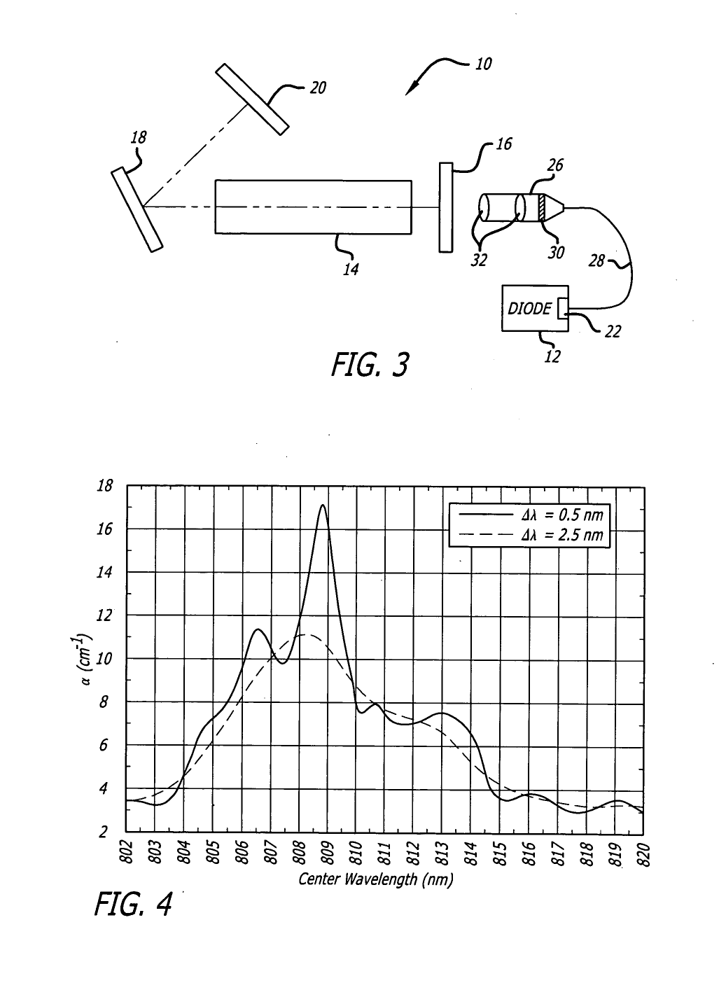

FIG. 3 illustrates an embodiment of an optical system in the form of a laser system 10 that incorporates narrow band pumping from a diode pump source 12. The laser system 10 includes a laser gain medium 14 disposed between a first reflective optic 16 and a second reflective optic 18. The first reflective optic 16 is reflective to light having a desired lasing wavelength of the laser gain material 14, but is relatively transmissive with respect to a pump light wavelength of the diode pump source 12. For example, for some embodiments, the desired lasing wavelength of the laser gain material 14 may be about 1000 nm to about 1100 nm, more specifically, about 1064 nm, and the pump light wavelength may be about 800 nm to about 900 nm. The second reflective optic 18 is also reflective to light having a desired lasing wavelength of the laser gain material 14, but need not be transmissive with respect to a pump light wavelength of the diode pump source 12 unless an optional second pump light source (not shown) is included adjacent the second reflective optic 18. The second reflective optic 18 is angled such that light at a desired lasing wavelength will be reflected to a third reflective optic 20 which, together with the first reflective optic 16 and second reflective optic 18, form a lasing cavity. The third reflective optic 20 may be partially transmissive to the desired lasing wavelength to serve as an output coupler for the laser system 10. Although laser system 10 includes three reflective optics 16, 18 and 20, similar laser systems may be used that include only 2 reflective optics. In addition, laser systems having 2, 3, 4 or more optics in the laser cavity are contemplated wherein the optics may include reflective optics, lenses, waveplates, polarizers or the like.

The laser gain material 14 may include a variety of materials including gases, liquids and solids including semiconductor materials. Specific materials may include neodymium doped vanadate (Nd:YVO₄), ytterbium doped tungstates (Yb:KGW, Yb:KYW or KYbW, collectively known as Yb:tungstate), Yb:SYS, Yb:BOYS, Yb:GdCOB, Yb:CaF, Nd:KGW, Cr:LiSAF, Cr:LiCAF, Ti:sapphire, Nd:YLF, Nd:GdVO₄ or any other suitable material. Some or all of these gain materials 14 may be incorporated and used in a variety of configurations such as bars, optical fibers, sections of optical fibers and the like. Some embodiments of the laser gain material 14 may have a length of about 8 mm to about 16 mm and a transverse dimension of about 2 mm to about 6 mm, however, other suitable lengths and transverse dimensions may also be used. The transverse cross section of the laser gain material 14 may be square, rectangular, round or any other suitable shape.

The diode pump source 12 is coupled to a bandwidth narrowing element in the form of a VBG 22 which may be enclosed within a housing of the diode pump source 12 or disposed externally to the diode pump source 12 and optically coupled to the diode pump source 12 with an optical coupler such as an optical conduit in the form of an optical fiber. An output of pump light from the VBG 22 is optically coupled to a pump source output element 26 by an optical coupler in the form of an optical fiber or optical fiber bundle 28 but any other suitable optical coupler may be used. The VBG 22 may serve to provide optical feedback to the diode pump source 12 which causes the diode pump source 12 to emit a narrow band light energy output. As an alternative, a narrow band spectal filter could be used in order to produce a narrow band output from the diode pump source 12. The pump source output element 26 includes a polarization scrambling element 30 and collimating optics 32 that are configured to collimate the pump light emitted from the optical fiber 28 and the polarization scrambling element 30. The polarization scrambling element 30 generally may be used to produce pump light output that is substantially un-polarized in some embodiments. Embodiments of the VBG 22 may be configured to emit embodiments of narrow band pump light having a bandwidth of less than about 0.7 nm, specifically, a bandwidth of about 0.2 nm to about 0.7 nm, and more specifically, a bandwidth of about 0.3 nm to about 0.5 nm.

Narrow bandwidth pump light may be emitted from the diode pump source 12 and directed from the pump source output element 26 into the laser gain material 14 in order to pump the laser gain material 14 and produce a laser beam that may be emitted from the third reflective optic 20. In this way, the detrimental effects that degrade the laser system performance which are functions of wavelength variation or bandwidth may be reduced or eliminated. The laser system 10 may also include the use of pump diode source 12 that emits pump light having a wavelength that encompasses or is otherwise at or near an intersection of data curves representing different pump light polarizations on a graph of pump light absorption coefficient versus wavelength of pump light. The pump diode source 12 may also emit pump light having a wavelength that is centered or substantially centered at a wavelength where absorption coefficients of pump light of different polarizations are substantially the same. The characteristics discussed above may be applied to an optical system where the laser gain material 14 is configured for use as either a laser oscillator or laser amplifier.

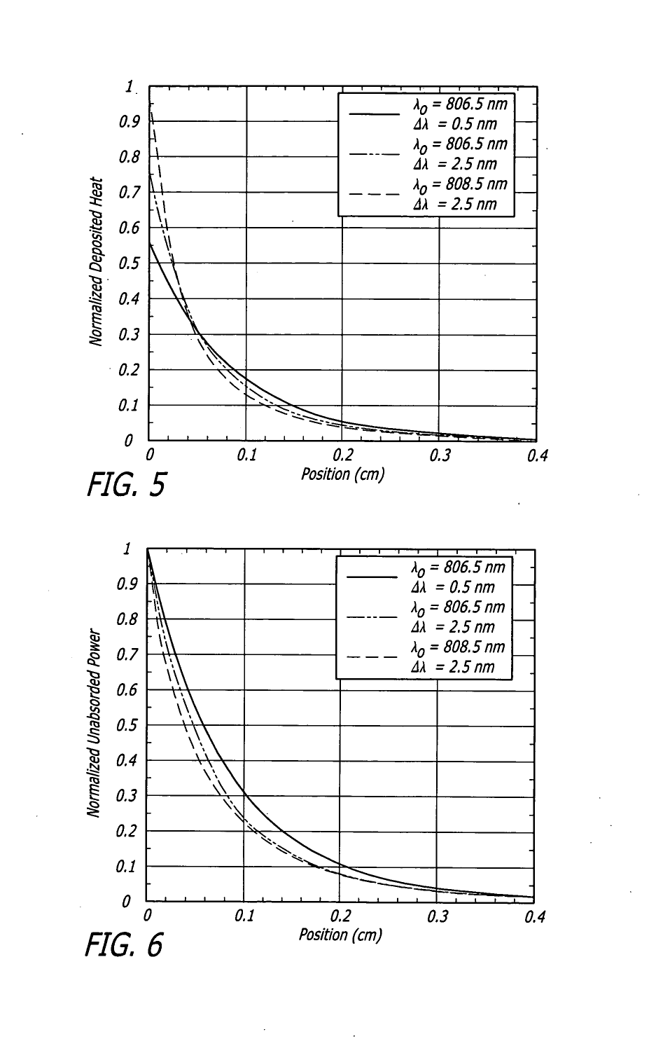

By way of example and without limitation, FIG. 4 compares the effective absorption coefficients in a 1% Nd:YVO₄ laser gain material for input bandwidths of about 0.5 nm and about 2.5 nm. From the figures, it is evident that by using a pump source centered at about 806.5 nm and having a bandwidth of about 0.5 nm, it is possible to achieve about the same absorption as a broader bandwidth source that is centered at about the peak of the absorption near 809 nm. By referring also to FIG. 1, it is evident that the absorption coefficients for both polarizations are very close in magnitude at wavelengths near 806.5 nm, so that the disadvantages of using unpolarized light are minimized. For the case of narrow band light near 806.5 nm, both polarizations are more uniformly absorbed so that the heat deposited near the pumped input surface of the gain material, which may be a crystal, is reduced compared to the case of broadband light centered near the peak of the absorption. This is illustrated in FIGS. 5 and 6, which compare the heat deposited and the variation of unabsorbed pump power in Nd:YVO₄ for narrow band pump light near 806.5 nm, and broadband pump light near 806.5 nm and 809 nm.

In FIGS. 5 and 6, the solid lines show data for the narrow band pump light centered at 806.5 nm, the dash-dotted lines show data for broadband pump light centered at 806.5 nm, and the dashed lines show data for broadband pump light centered at about 808.5 nm. For the embodiments shown, the Nd concentration for the lasing material is about 1.3% for the broadband pump light centered at about 806.5 nm and the Nd concentration for the lasing material of the other data embodiments is about 1%. The heat load at the front of the gain material is lower for the case of narrow band pump light centered at 806.5 nm, even though the total absorbed pump light remains about the same.

Using a broadband pump source near 806.5 nm would give some improvement over pumping near the absorption peak of the gain material because the relative difference between the effective absorption coefficients is reduced. However, because the total absorption is reduced for the case of broadband pumping near 806 nm, it may be necessary to increase the doping and/or the length of the laser gain material to keep the total absorbed pump light power constant, and this increases the heat load near the input face of the laser gain material. In this example, the doping is increased by about 30% to keep the total absorption substantially constant. Narrow band pumping, on the other hand, allows the laser gain material parameters to remain unchanged, and can further reduce the relative difference between the effective absorption coefficients. FIGS. 5 and 6 show that this embodiment provides a lower heat load near the pumped laser gain crystal surface.

It is important to point out that the embodiments discussed herein do not require that the curves of the pump light absorption versus pump light wavelength for both polarization orientations cross at or near the operating point, or that the values be equal. As demonstrated by the above example, the absorption values may be close enough over some (possibly narrow) bandwidth for some embodiments so that the absorptions for each polarization will be more or substantially equal throughout the laser gain material.

Embodiments may also be applied to any laser gain material that has polarization or direction dependant absorption coefficients, and is not limited to the specific embodiments discussed herein. Examples of other embodiments may include Nd:YVO₄ when pumped near 880 nm and Yb:tungstate when pumped near 940 nm and near 981 nm. It will also be appreciated that embodiments can generally be applied to materials other than laser gain materials that absorb laser radiation and produce thermo-optical, thermo-mechanical or other detrimental effects. They can further be applied to enable the efficient and stable pumping of relatively narrow absorption features such as those present in Yb:tungstate near 980 nm.

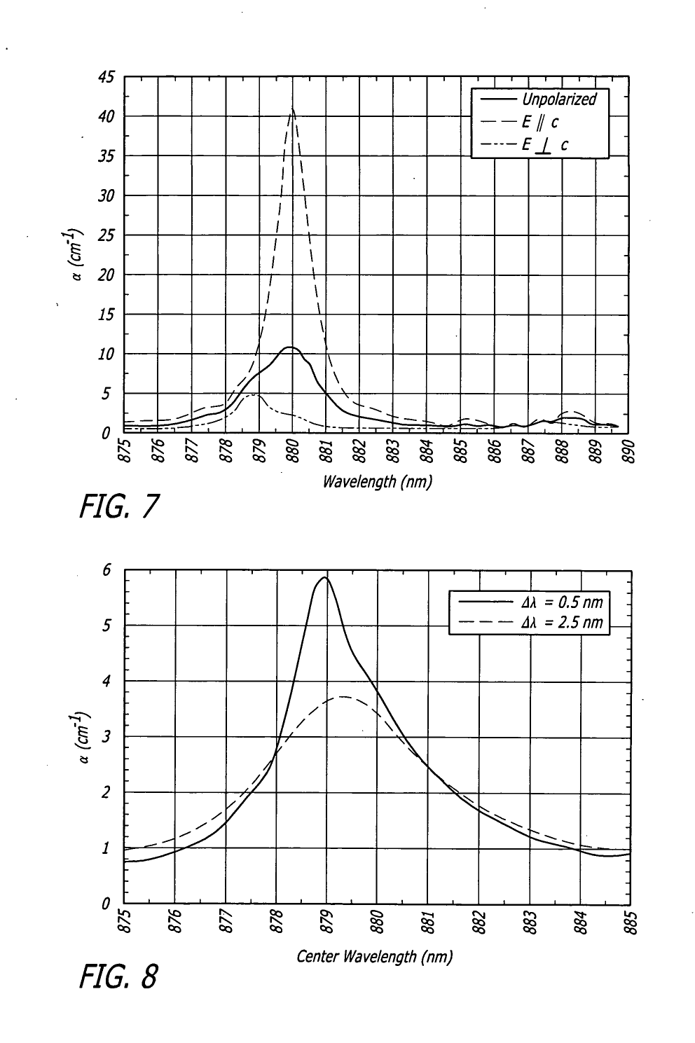

Again, by way of example and without limitation, consider the absorption characteristics of Nd:YVO₄ near 880 nm. Data illustrating the absorption coefficients for pump light having polarizations both parallel and perpendicular to the c-axis are shown together with data illustrating the effective coefficient for unpolarized light in FIG. 7. The absorption curves for the two polarizations cross several times near 888 nm, but as in the case of pumping near 808 nm, the values are significantly smaller that those at the peak, requiring longer, more highly doped gain materials for adequate pump absorption.

In FIG. 8 the effective absorption curves are shown for the case of a relatively broadband pump light versus a relatively narrow band pump light. The solid line indicates data for pump light having a bandwidth of about 0.5 nm and the dashed line indicates data for pump light having a bandwidth of about 2.5 nm in a 1% Nd:YVO₄ lasing material. Again, at wavelengths near about 878 nm, the pump absorption for the narrow band source is about the same as that for the broadband pump light source centered near the peak. The values of the absorption coefficients are much closer together at this point than at the peak absorption. In such cases where the absorption coefficients are close together or substantially equal, even though they are not equal and/or do not cross/intersect, light of both polarizations may still be more uniformly absorbed in the laser gain crystal than in the case of pumping the laser gain material at the peak absorption wavelength.

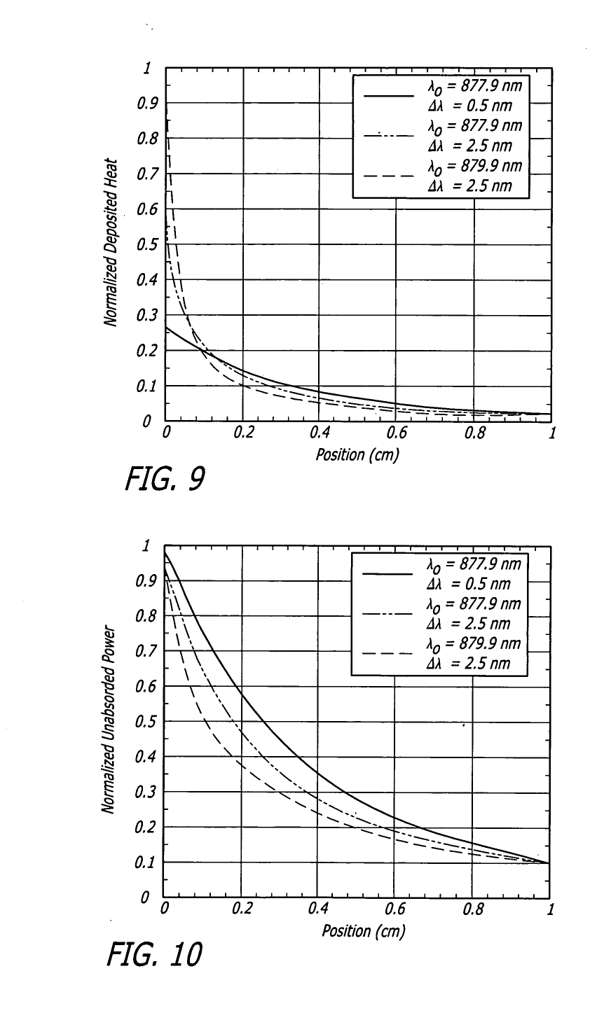

This is further illustrated in FIGS. 9 and 10, which show that the heat deposited near the pumped surface of the laser gain material and the differential absorption is greatly reduced by light source 880 nm, even though the overall pump light absorption is about the same in both cases. In FIGS. 9 and 10, the solid line shows data for narrow band pump light centered at about 877.9 nm, the dash-dotted line shows data for broadband pump light centered at about 877.9 nm and the dashed line shows data for broadband pump light centered at about 879.9 nm. For the embodiments shown in FIGS. 9 and 10, the Nd concentration of the lasing material is about 1.3% for the broadband pump light data centered at about 877.9 nm and about 1% for data in all other cases. Again, the intermediate case of pumping with a broadband source near 877.9 nm provides some improvement when compared to pumping with the same source near 880 nm, however, the narrow band pump near 878 nm provides a yet lower heat load near the pumped surface of the gain material.

Note that because the peak absorptions for the two polarizations are offset with respect to each other in wavelength, even if a broadband pump source were used, the best absorption would be obtained at a wavelength near 879 nm, which is on the short wavelength side of the main absorption peak. This would also provide better heat distribution properties because the differential absorption between the two polarizations is lower than at the peak absorption near 880 nm.

Embodiments discussed herein may refer to the same laser gain material or families of materials. The method and device embodiments discussed herein may be used with existing laser gain materials, and do not require new dopings or laser gain material dimensions, such as length. This allows the possibility to improve the performance of existing lasers by simply replacing the existing broadband pump modules or sources with narrow band pump modules or sources at an optimized or otherwise desirable wavelength.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. A laser system, comprising
a laser gain material; and
a narrow band pump source configured to produce pump light at or near a wavelength where the absorption coefficients for pump light having different polarizations are substantially equal in the laser gain material.

2. The laser system of claim 1 wherein the narrow band pump source comprises a diode pump source optically coupled to a VBG.

3. The laser system of claim 1 wherein the narrow band pump source comprises a diode pump source optically coupled to a wavelength selective coating.

4. The laser system of claim 1 wherein the laser gain material comprises an anisotropic material.

5. The laser system of claim 1 further comprising a telescope element which produces an output beam directed to the laser gain material and which is optically coupled to the narrow band pump source with an optical fiber.

6. The laser system of claim 5 further comprising a polarization scrambler between the optical fiber and the laser gain material.

7. The laser system of claim 1 wherein the laser gain material comprises a vanadate material.

8. The laser system of claim 1 wherein the laser gain material comprises a tungstate material.

9. A method of pumping a laser system, comprising pumping a laser gain material with a narrow band pump light having a wavelength centered substantially at a point where the absorption coefficients for different polarization orientations of pump light are substantially equal in the laser gain material.

10. The method of claim 9 wherein pumping the laser gain material with a narrow band pump light comprises passing the pump light through a VBG.

11. The method of claim 9 wherein pumping the laser gain material with a narrow band pump light comprises passing the pump light through a wavelength selective coating.

12. The method of claim 9 wherein the narrow band pump light comprises light having a bandwidth of less than about 0.7 nm.

13. The method of claim 12 wherein the narrow band pump light comprises light having a bandwidth of about 0.2 nm to about 0.7 nm.

14. The method of claim 13 wherein the narrow band pump light comprises light having a bandwidth of about 0.3 nm to about 0.5 nm.

15. The method of claim 9 wherein pumping the laser gain material comprises emitting pump light from a diode pump source having a wavelength centered substantially at an intersection of absorption coefficients for different polarizations of pump light in the laser gain material.

16. A method of selecting pump light for a laser gain material, comprising selecting pump light having a center wavelength and bandwidth configured to optimize the uniformity of a heat load caused by pump light throughout the laser gain material.

17. A method of imparting laser energy on a material, comprises pumping the material with a narrow band pump light having a wavelength centered substantially at a point where the absorption coefficients for different polarization orientations of the pump light are substantially equal in the material.

18. The method of claim 17 wherein pumping the material with a narrow band pump light comprises passing the pump light through a VBG.

19. The method of claim 17 wherein pumping the material with a narrow band pump light comprises passing the pump light through a wavelength selective coating.

20. The method of claim 17 wherein the narrow band pump light comprises light having a bandwidth of less than about 0.7 nm.

21. The method of claim 20 wherein the narrow band pump light comprises light having a bandwidth of about 0.2 nm to about 0.7 nm.

22. The method of claim 21 wherein the narrow band pump light comprises light having a bandwidth of about 0.3 nm to about 0.5 nm.

23. The method of claim 17 wherein pumping the material comprises emitting pump light from a diode pump source having a wavelength centered substantially at an intersection of absorption coefficients for different polarization orientations of pump light in the material.
